(19) United States
(12) Patent Application Publication
(10) Pub. No.: US 2011/0170418 A1
(43) Pub. Date: Jul. 14, 2011

(54) Measurement Event Evaluation for Triggering Measurement Reports

(75) Inventors: Mats Sågfors, Kyrkslatt (FI); Walter Müller, Upplands Vasby (SE)

(73) Assignee: Telefonaktiebolaget L M Ericsson (publ), Stockholm (SE)

(21) Appl. No.: 12/960,824

(22) Filed: Dec. 6, 2010

Related U.S. Application Data
(63) Continuation of application No. PCT/EP2010/068741, filed on Dec. 2, 2010.
(60) Provisional application No. 61/293,887, filed on Jan. 11, 2010.

(51) Int. Cl. H04L 12/26

(52) U.S. Cl. 370/241

(57) ABSTRACT

Measurement event evaluation is of interest in a user equipment (UE) configured with multiple downlink component carriers (CCs). The UE performs measurements of a neighbor and a specific one of the configured CCs, being used as a reference CC. The UE evaluates, based on the measurements of the neighbor and the reference CC, being a specific one of the configured CCs, an evaluation criterion for triggering a measurement report from the UE. In this way, the number of event evaluations and measurement reports can be reduced, since a specific reference CC is used for the purpose of measurement event evaluation in a scenario when the UE is configured with multiple CCs.

This application claims the benefit of the filing dates of U.S. Provisional Patent Application No. 61/293,887 filed on Jan. 11, 2010, and International Application No. PCT/EP2010/068741 filed on Dec. 2, 2010, both of which are incorporated here by reference.

### BACKGROUND

Carrier Aggregation

The Third Generation Partnership Project (3GPP) Long Term Evolution (LTE) Release 8 (Rel-8) standard for wireless communication systems has recently been finalized, supporting bandwidths up to 20 megahertz (MHz). LTE and High-Speed Packet Access (HSPA) are sometimes called “third generation” (3G) communication systems and are currently being standardized by the 3GPP. The LTE specifications can be seen as an evolution of the current wideband code division multiple access (WCDMA) specifications.

An LTE system uses orthogonal frequency division multiplex (OFDM) as a multiple access technique (called OFDMA) in the downlink (DL) from system nodes to user equipments (UEs). An LTE system has channel bandwidths ranging from about 1.4 MHz to 20 MHz, and supports throughputs of more than 100 megabits per second (Mb/s) on the largest-bandwidth channels. One type of physical channel defined for the LTE downlink is the physical downlink shared channel (PDSCH), which conveys information from higher layers in the LTE protocol stack and to which one or more specific transport channels are mapped. Control information is conveyed by a physical uplink control channel (PUCCH) and by a physical downlink control channel (PDCCH). These and additional LTE channels are described in 3GPP Technical Specification (TS) 36.211 V8.4.0, Physical Channels and Modulation (Release 8) (September 2008), among other specifications.

An IMT-Advanced communication system uses an internet protocol (IP) multimedia subsystem (IMS) of an LTE, HSPA, or other communication system for IMS multimedia telephony (IMT). In the IMT advanced system (which may be called a “fourth generation” (4G) mobile communication system), bandwidths of 100 MHz and larger are being considered. The 3GPP promulgates the LTE, HSPA, WCDMA, and IMT specifications, and specifications that standardize other kinds of cellular wireless communication systems.

In order to meet the upcoming IMT-Advanced requirements, 3GPP has initiated work on LTE-Advanced. One of the parts of LTE-Advanced is to support bandwidths larger than 20 MHz. This will be achieved using a concept called “Carrier Aggregation”, where multiple carrier components, each of which may be up to 20 MHz wide, are aggregated together. Carrier aggregation is planned for Release 10 (Rel-10) of the 3GPP LTE specifications.

Carrier aggregation implies that an LTE Rel-10 terminal can receive multiple component carriers, where the component carriers have, or at least the possibility to have, the same structure as a Rel-8 carrier. Carrier aggregation is illustrated in FIG. 1, in which 5 bands of 20 MHz each are aggregated together.

Carriers can be aggregated contiguously, as in FIG. 1, or they may be aggregated from discontinuous portions in the frequency domain, such that, e.g., parts of the aggregated carriers may be contiguous, and other aggregated carriers appear somewhere else in the spectrum, as schematically illustrated in FIG. 2.

The artisan will understand that the blocks shown in FIGS. 1 and 2 are compliant with the LTE specifications. With the carrier aggregation concept, it is possible to support, among other things:
higher bit-rates;
farming of non-contiguous spectrum—e.g., provide high bit-rates and better capacity in cases when an operator lacks contiguous spectrum;
fast and efficient load balancing between carriers.

It should be noted that carrier aggregation is a user-equipment-centric concept, in that one user equipment (UE) can be configured to use, e.g., the two left-most carriers in FIG. 2, another UE can be configured to use only a single carrier, and a third UE can be configured to use all of the carriers depicted in FIG. 2.

Thus, an eNodeB (eNB) (i.e., an LTE radio base station) may be in control of all four carriers depicted in FIG. 2, but Rel-10 UEs may have different Configured Component Carriers (Configured CCs) that each Rel-10 UE is configured to use.

The aggregated carriers may also be available for Rel-8 UEs, meaning that each of the carriers may be independently available for single-cell operation.

A particular and relevant example of a plausible carrier aggregation scenario includes the case when two or more Rel-8 compatible downlink carriers are aggregated for a UE. It should be noted that carrier aggregation is typically and mainly relevant for a Connected UE, which is a UE that is actively involved in transmission to and from the eNB (which can generally be a E-UTRAN base station), and thus has a connection with the eNB controlling the aggregated carriers.

Mobility and Measurements

In Connected mode, mobility (i.e., handovers between eNBs) is controlled by the network based on, among other things, measurements provided to the network by the UE. Based on measurement reports received from the UE, the eNB may deduce if a handover is needed. If so, the eNB may then issue a handover to another cell, possibly so that the other cell is controlled by another eNB.

Measurement configurations are controlled by the eNB, i.e., the eNB tells the UE, e.g., when to perform measurements, what to measure, and how to report. Such controlling information sent from the eNB to the UE includes, e.g., information of how measurements should be filtered, different thresholds for the triggers that trigger report, what to measure, how to report, and what to include in the report.

The Rel-8 LTE specifications support a versatile measurement model where different events with thresholds can be configured, such that the UE sends measurement reports to the network when, e.g., the relative signal strength between the current “Serving Cell” and a “Neighbor Cell” is changing, such that a handover may be necessary. This can occur, e.g., when the UE moves from one cell to another, as depicted in FIG. 3, which is a plot of received signal level vs. time or distance.

In Rel-8, the “Serving Cell” denotes the cell that the UE is connected to, while the “Neighbor Cell” may be another cell in close proximity on the same frequency (intra-frequency measurements), or on a different frequency (inter-frequency measurements). The Neighbor may also use a different Radio Access Technology (inter-RAT measurements).

Rel-8 includes different event-triggers for issuing reports from the UE to the eNB, when certain conditions are fulfilled. Existing triggers in LTE Rel-8 include the following:
E-UTRA triggers:
Event A1: Serving cell becomes better than absolute threshold;
Event A2: Serving cell becomes worse than absolute threshold;
Event A3: Neighbor cell becomes amount of offset better than serving;
Event A4: Neighbor cell becomes better than absolute threshold;
Event A5: Serving cell becomes worse than absolute threshold1 AND Neighbor cell becomes better than another absolute threshold2.

There are also entering and leaving conditions specified utilizing hysteresis parameters.
Inter-RAT triggers:
Event B1: Neighbor cell becomes better than absolute threshold;
Event B2: Serving cell becomes worse than absolute threshold1 AND Neighbor cell becomes better than another absolute threshold2.

In the 3GPP Technical Specification (TS) 25.331 V9.0.0, Radio Resource Control (Release 9) (September 2009), UTRAN trigger events are defined.

Different trigger configurations include various thresholds, configurable parameters, and entering and leaving conditions such that the desired measurements can be received from the UE. As a simple example, Event A1 includes both entering and leaving conditions:

Ms−Hys>Thresh Inequality A1-1 (Entering condition)

Ms+Hys<Thresh Inequality A1-2 (Leaving condition)

where Ms is the filtered measurement, Thresh is a configurable threshold, and Hys is a hysteresis parameter for this event, as illustrated by FIG. 4, which is a plot of received signal level vs. time or distance.

For clarity reasons, we here also list some of the nomenclature used in the LTE specification, 3GPP Technical Specification (TS) 36.331 V8.8.0, Evolved Universal Terrestrial Radio Access (E-UTRA) Radio Resource Control (RRC), Protocol Specification (Release 8) (December 2009), Clause 5.5:
1. Measurement objects: The objects on which the UE shall perform the measurements.
2. Reporting configurations: A list of reporting configurations including e.g. the aforementioned trigger configurations.
3. Measurement identities: A list of measurement identities where each measurement identity links one measurement object with one reporting configuration.

Additional definitions can be found in Clause 5.5 of 3GPP TS 36.331, for example.

Thus, it can be seen that a trigger (e.g., event A3) can be configured with a reporting configuration, and this configuration can then be linked to different objects (on separate carriers), such that the same configuration is applied on multiple measurement objects. Similarly, it is possible to link multiple reporting configurations to one object.

Considering Event A3, for example, it is thus possible to configure an A3-event on a measurement object, such that if any Neighbor on that object grows stronger than the Serving cell (plus some configurable thresholds), then the UE shall send a measurement report that includes information about the measured radio environment of the UE. The report is constructed with relevant information, such that the eNB can decide if a handover is required or at least beneficial.

The measurement object may be the carrier “defined” by the Serving Cell (in which case the Neighbor and Serving are on the same frequency), or the object may be a different, inter-frequency object, as illustrated by FIG. 5.

The same, or different, reporting configurations for A3 (or other) events could be configured for the two objects in the figure.

A characteristic of this Rel-8 model of relevance for the present invention is the fact that the UE has a single Serving Cell.

A problem with the measurement configuration and event triggers arises when Carrier Aggregation is introduced. Now, a UE may be “served” on multiple frequencies, and there arises an ambiguity of what the “Serving Cell” in FIG. 5 actually is. Specifically, the 3GPP RAN2 working group has recently agreed that each component carrier is a separate measurement object, as illustrated in FIG. 6.

Further reference can be made to 3GPP R2-100826: Report of 3GPP TSG RAN WG2 meeting #68 held Nov. 9-13, 2009.

In terms of the Rel-8 model, the UE now has three serving cells.

Assume now that a UE is configured with three Component Carriers (CCs). With Rel-8 nomenclature, the UE in FIG. 6 would now have three “Serving Cells”. The term “Component Carrier”, or CC, may for example be defined as a downlink (DL) frequency that a UE is currently configured with, such that the UE is prepared to receive that DL carrier. In the following the terms “Component Carrier” and “serving cell” will be used more or less interchangeably.

FIG. 7 is a schematic diagram illustrating of an example of a situation when a UE is served by multiple serving cells or carrier components. FIG. 7 shows a first base station 1 and a second base station 2. The first base station 1 is currently a serving base station serving a user equipment, UE, 3 and the second base station 2 is a neighbor base station. As mentioned above, the UE 3 may be configured with multiple serving cells, or so-called component carriers, CCs, which relate to carriers on different frequencies (f).

A straightforward adaptation of the Rel-8 triggers to carrier aggregation is to assume that a UE now has multiple “serving cells”, or CCs, and that, e.g., Trigger A3 should now be evaluated against each CC, as illustrated by FIG. 8.

In FIG. 8, two neighbors are illustrated for a UE with three configured CCs. It is also assumed that the UE has three CCs, and a trigger A3 is configured for Object 1 and Object 4.

Reference can also be made to 3GPP R2-096800: Measurement Considerations for Multicarrier Operation; Document for discussion and decision at 3GPP TSG RAN WG2 meeting #68, November 2009.

However, such an implementation of the Rel-8 solution will easily result in very many triggers being fulfilled about at the same time, e.g., when a UE moves away from the eNB, resulting a flooding of unnecessary measurement reports.

### SUMMARY

This invention provides improved measurement event evaluation in user equipment configured with multiple downlink component carriers.

In particular it is desirable to reduce the number of event evaluations and measurement reports.

In a first aspect, there is provided a method for measurement event evaluation in a user equipment, UE, configured with multiple downlink component carriers, CCs. A basic idea is to perform measurements of a neighbor and a specific one of the configured CCs, being used as a reference CC. Based on the measurements of the neighbor and the reference CC, being the specific one of the configured CCs, an evaluation criterion for triggering a measurement report from the UE is then evaluated.

In this way, the number of event evaluations and measurement reports can be reduced, since a specific reference CC is used for the purpose of measurement event evaluation.

In a second aspect, there is provided a control unit for measurement event evaluation in a user equipment, UE, configured with multiple downlink component carriers, CCs. The control unit comprises at least one processing circuit configured to evaluate, based on measurements of a neighbor and a reference CC, an evaluation criterion for triggering a measurement report from the UE, where the reference CC is a specific one of the configured CCs.

In a third aspect, there is provided a user equipment, UE, configured for measurement event evaluation. The UE is configured with multiple downlink component carriers, CCs, and comprises at least one measurement circuit configured to perform measurements of a neighbor and a specific one of the configured CCs, being used as a reference CC. The UE also comprises at least one processing circuit configured to evaluate, for the neighbor and the reference CC, being the specific one of the configured CCs, an evaluation criterion for triggering a measurement report from the UE.

In a fourth aspect, there is provided a non-transitory computer-readable medium having stored therein a set of instructions for performing, when executed by a computer-based system, measurement event evaluation in a user equipment, UE, configured with multiple downlink component carriers, CCs. In the measurement event evaluation, an evaluation criterion for triggering a measurement report from the UE is evaluated for a neighbor and a reference CC, where the reference CC is one of the configured CCs.

Other advantages offered by the invention will be appreciated when reading the below description of embodiments of the invention.

### BRIEF DESCRIPTION OF THE DRAWINGS

The invention, together with further objects and advantages thereof, may best be understood by making reference to this description taken together with the accompanying drawings, in which:

FIG. 1 is a schematic diagram illustrating the concept of carrier aggregation.

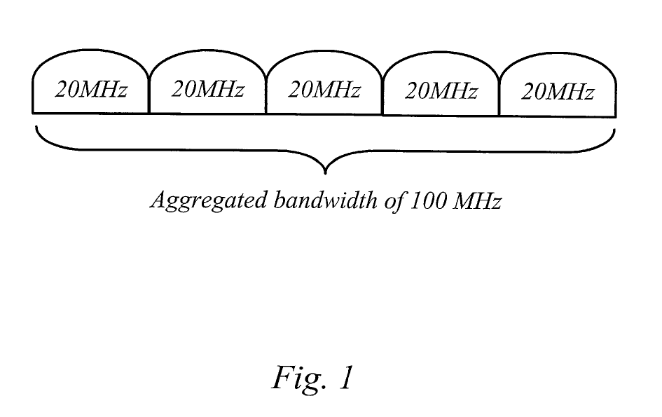

FIG. 2 is a schematic diagram illustrating contiguous and non-contiguous carriers with different bandwidths.

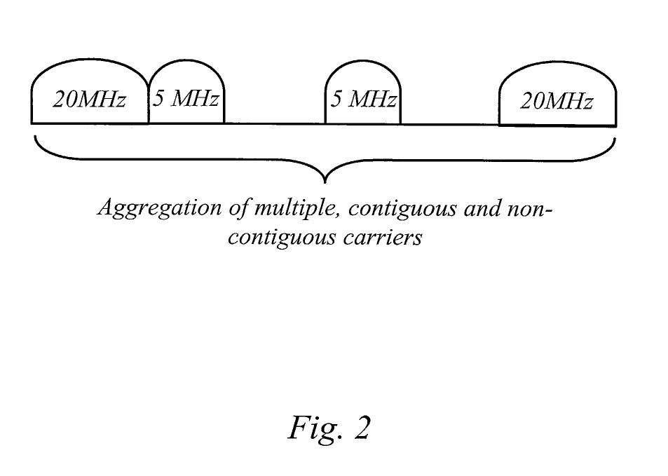

FIG. 3 is a schematic diagram illustrating an example of a handover measurement model.

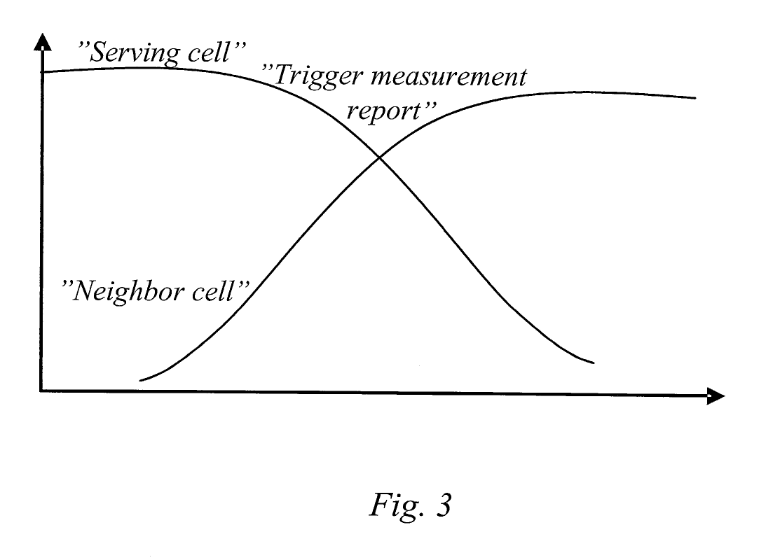

FIG. 4 is a schematic diagram illustrating an example of handover trigger events and thresholds.

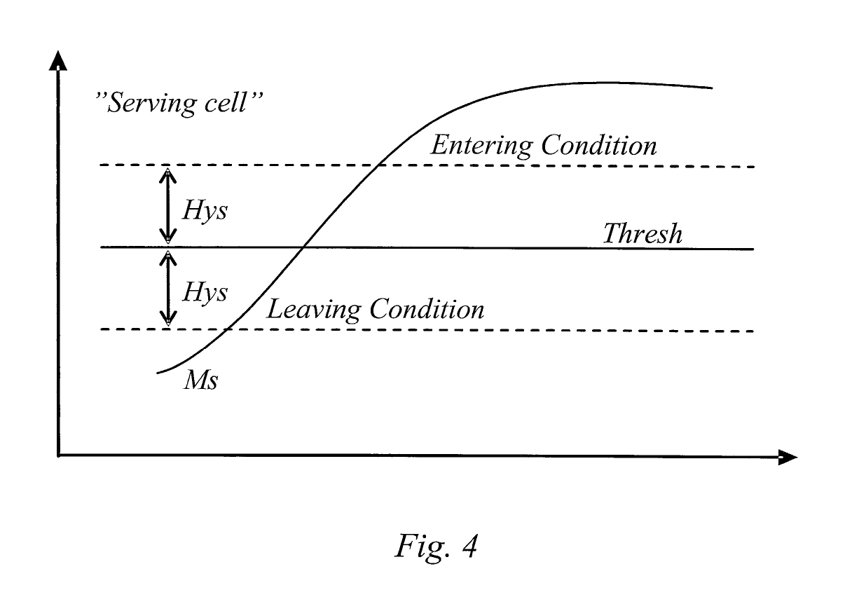

FIG. 5 is a schematic diagram illustrating an example of A3 events applied both to an intra-frequency and inter-frequency object.

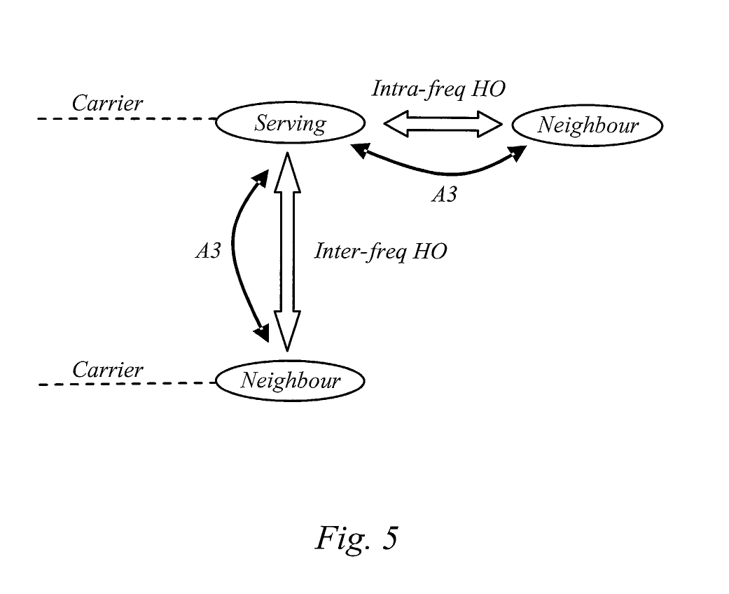

FIG. 6 is a schematic diagram illustrating an example of a situation when a UE is configured with three DL component carriers.

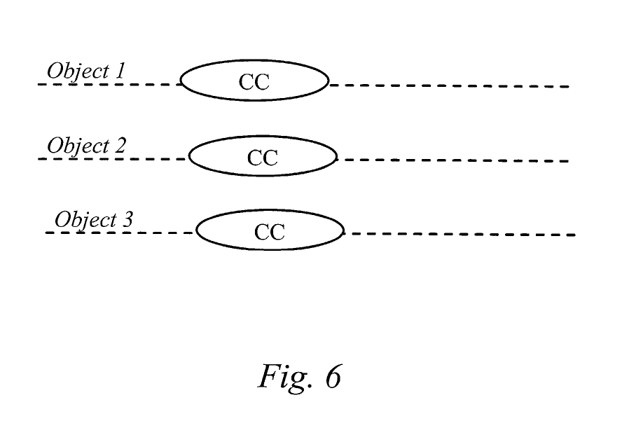

FIG. 7 is a schematic diagram illustrating of an example of a situation when a UE is served by multiple serving cells or carrier components.

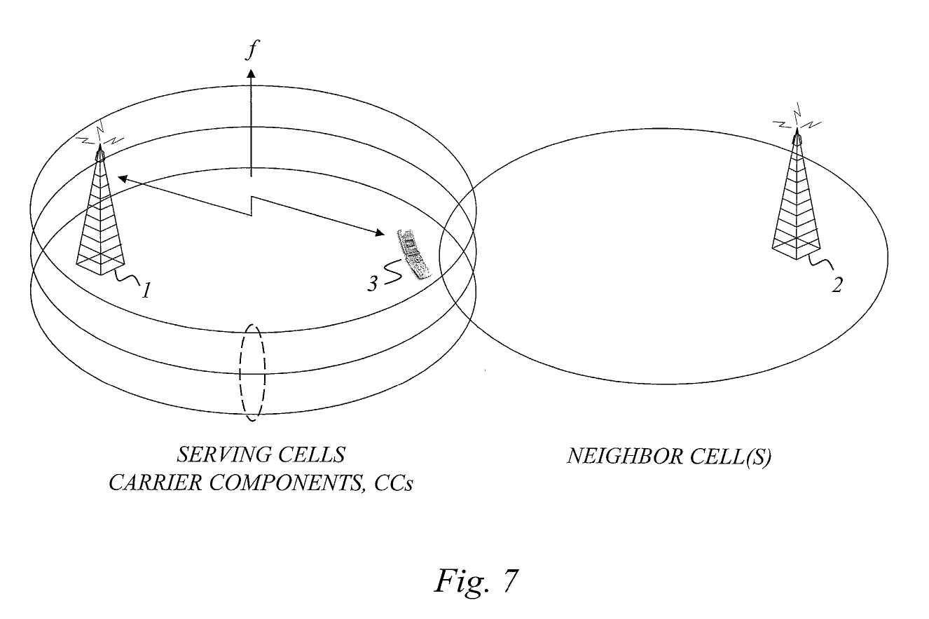

FIG. 8 is a schematic diagram illustrating an example of a Rel-8-model implementation to carrier aggregation, where a neighbor is evaluated against each CC.

FIG. 9 is a schematic flow diagram illustrating an example of a method for measurement event evaluation according to an embodiment.

FIG. 10 is a schematic diagram illustrating a possible solution for event evaluation on a carrier that includes a CC.

FIG. 11 is a schematic diagram illustrating the problem related to inter-frequency event evaluation.

FIG. 12 is a schematic diagram illustrating a situation where the relative strength of CC varies.

FIG. 13 is a schematic diagram illustrating an example of a UE having three CCs.

FIG. 14 is a schematic diagram illustrating an example of a UE comparison of cells on objects.

FIG. 15 is a schematic diagram illustrating an example of a control unit for measurement event evaluation according to an embodiment of the invention.

FIG. 16 is a schematic diagram illustrating an example of a user equipment configured for measurement event evaluation according to an embodiment of the invention.

FIG. 17 is a schematic diagram illustrating an example of a typical cellular radio communication system.

FIG. 18 is a schematic block diagram illustrating an example of a portion of a user equipment according to an embodiment.

FIG. 19 is a schematic diagram illustrating an example of a computer-implemented control unit for measurement event evaluation, as well as a computer-readable medium according to an embodiment.

FIG. 20 is a schematic flow diagram of an example of a method for measurement event evaluation according to another embodiment.

### DETAILED DESCRIPTION

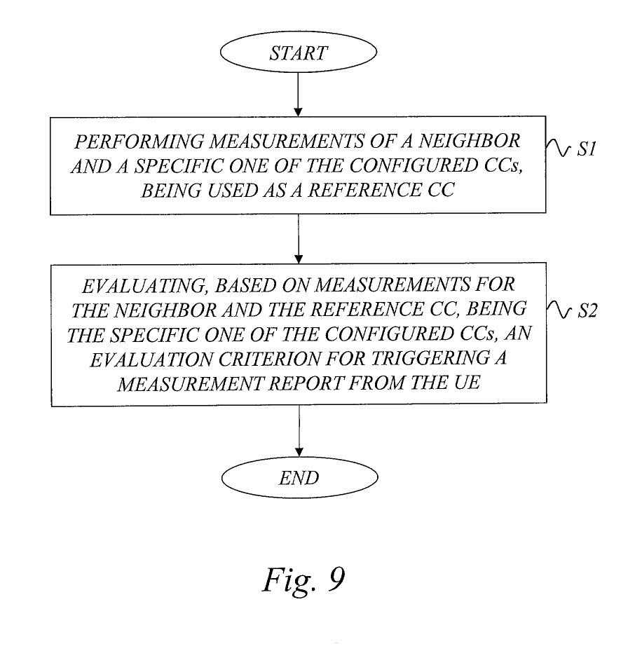

FIG. 9 is a schematic flow diagram illustrating an example of a method for measurement event evaluation in a user equipment, UE, configured with multiple downlink component carriers, CCs, also referred to as serving cells according to an embodiment.

In step S1, the UE performs measurements of a neighbor and a specific one of the configured CCs, being used as a reference CC. In step S2, the UE evaluates, based on measurements of the neighbor and the reference CC, being the specific one of the configured CCs, an evaluation criterion for triggering a measurement report from the UE.

In this way, the number of event evaluations and measurement reports can be reduced, since a specific reference CC is used for the purpose of measurement event evaluation in a scenario when the UE is configured with multiple CCs.

For example, the UE may receive information representative of the reference CC, with the reference CC being selected and controlled with higher-layer signaling and/or the reference CC being signaled using the Radio Resource Control, RRC, protocol. The UE may then maintain information about the reference CC as the CC to be used in the measurement evaluation.

By way of example, the so-called PCell, or Primary Cell, may be used as the reference CC. The PCell can be changed by a handover command from the base station. Thus, the reference CC may be selected and controlled with higher-layer signaling. For example, the reference CC can be signaled using the Radio Resource Control, RRC, protocol. In another example, particularly for intra-frequency use, the reference CC may be the SCell, Secondary Cell, on the carrier object.

The network may perform a change of PCell and/or SCell by RRC signaling. For example, in E-UTRAN, the eNB may perform a PCell change by means of the handover procedure, i.e. using an RRCConnectionReconfiguration message including mobilityControlInfo. SCell change may be performed by means of the RRC connection reconfiguration procedure, i.e. using the RRCConnectionReconfiguration message not including mobilityControlInfo.

In the 3GPP document R2-097514: Report of 3GPP TSG RAN WG2 meeting #67bis held Oct. 12-16, 2009, a special cell that provides security input and NAS mobility information was introduced.

In an example embodiment, the UE may evaluate the evaluation criterion for the neighbor and the reference CC, being the specific one of the configured CCs, where the neighbor is on an inter-frequency carrier on which the UE has no configured CC.

The invention is generally applicable to so-called trigger events. For example, the measurement event evaluation includes evaluation of an event selected from the following group of events: A3, A5, and B2 trigger events. In a particular example, the measurement event evaluation includes evaluation of an event defined as: the neighbor becomes amount of offset better than the reference CC.

The evaluation criterion is normally evaluated with respect to physical layer measurements related to the neighbor and the reference CC.

If the evaluation criterion is fulfilled (and the event occurs), a measurement report, including information about the measured radio environment, is normally sent from the UE to a base station as a result of the measurement event evaluation, to thereby enable the base station to deduce if a handover is needed.

According to an aspect of the present invention, there is thus provided a method for measurement event evaluation in UEs configured with multiple downlink component carriers (CCs), where the evaluation criterion is evaluated for a neighbor and a reference CC, where the reference CC is one of the configured CCs.

According to an aspect of the present invention, there is provided a method for measurement event evaluation in UEs configured with multiple downlink component carriers, where the evaluation criterion is dependent on whether the measured object has a configured component carrier or not. In one example of the method, the event is evaluated both for a neighbor and a configured component carrier, and the reference CC to be evaluated is at least one of a first component carrier on the same frequency or object as the neighbor cell, if there is a component carrier on the frequency or object, and a different, second component carrier on a different frequency, if there is no component carrier on the frequency or object of the neighbor cell. The second component carrier can be the best component carrier of all configured component carriers of the UE.

According to further aspects of the present invention, apparatus in user equipments and computer-readable media for measurement event evaluation are provided.

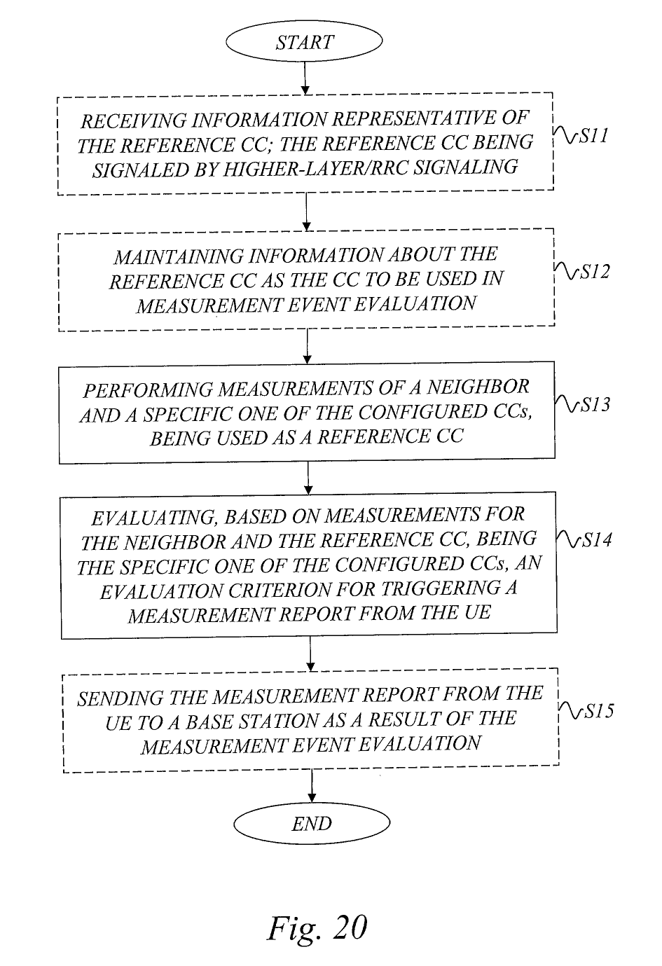

FIG. 20 is a schematic flow diagram of an example of a method for measurement event evaluation according to another embodiment. In optional step S11, information representative of the reference CC is received, the reference CC being selected/signaled by higher-layer/RRC signaling. In optional step S12, information about the reference CC as the CC to be used in the measurement event evaluation is maintained by the UE. In step S13, the UE performs measurements of a neighbor and a specific one of the configured CCs, being used as a reference CC. In step S14, the UE evaluates, based on measurements of the neighbor and the reference CC, being a specific one of the configured CCs, an evaluation criterion for triggering a measurement report from the UE. In optional step S15, the measurement report, including information about the measured radio environment, is sent from the UE to a base station as a result of the measurement event evaluation, to enable the base station to deduce if a handover is needed.

For a better understanding of the invention, it may be useful to review and analyze some of the problems.

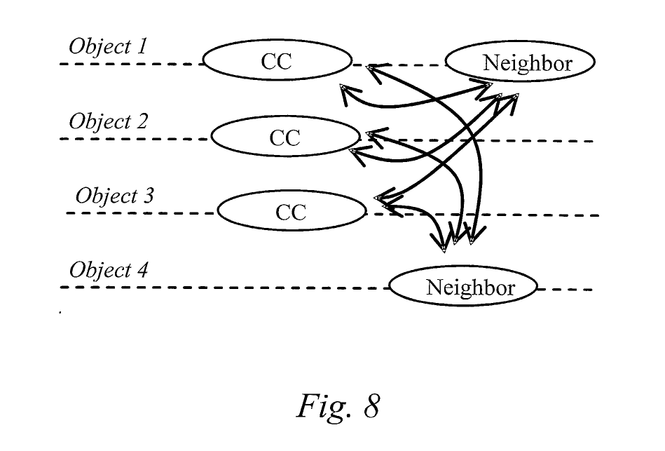

As already explained with reference to FIG. 8, a straightforward adaptation of Rel-8 triggers to carrier aggregation is to assume that a UE has multiple serving cells, or CCs, and that a trigger event should be evaluated against each CC. However, this may result in a flooding of measurement reports.

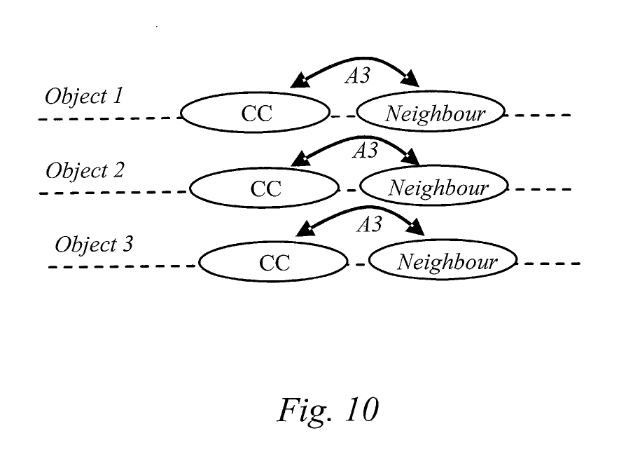

To alleviate this, event evaluation can be performed for “intra frequency” measurements on one frequency layer only, as illustrated in FIG. 10.

This would reduce the event evaluations and reports for measurements configured onto objects that include a CC (“intra-frequency”).

Further, it would be desirable to abstract the measurement configuration, such that the reference is not explicitly configured, particularly since the UE may undergo addition and removals of CCs. If the reference is a CC that is removed, or whose signal is so weak that the UE cannot detect it, will void the measurement configuration in question.

Further, it would be desirable to avoid introducing new trigger types to Rel-10, such that Rel-8 trigger definitions could be expanded to cover for the introduction of carrier aggregation.

It should also be noted in the problem description above that trigger A3 is merely used as a specific illustrative example. However, the same issue occurs for any trigger type, where the event includes an evaluation of both a neighbor on the object, and an evaluation of a “serving” cell or CC. Thus, of the existing triggers in for example LTE, and in addition to A3, the present invention is particularly relevant for triggers A5 and B2 that includes evaluation criteria for both a neighbor and the “serving” cell.

The quality or “goodness” (i.e., good, better, best, as used here) may be determined by evaluating some physical layer measurements, where a stronger or otherwise better physical layer measurement typically, and in current art, indicates that a cell or CC is “better” or “stronger” than the other. The quality is thus normally the signal quality such as received signal power or similar measure of signal strength. In LTE, such measurements may include for example RSRP (Reference Signal Received Power) and RSRQ (Reference Signal Received Quality). However, the present invention is equally applicable to any measurement related to the measured object.

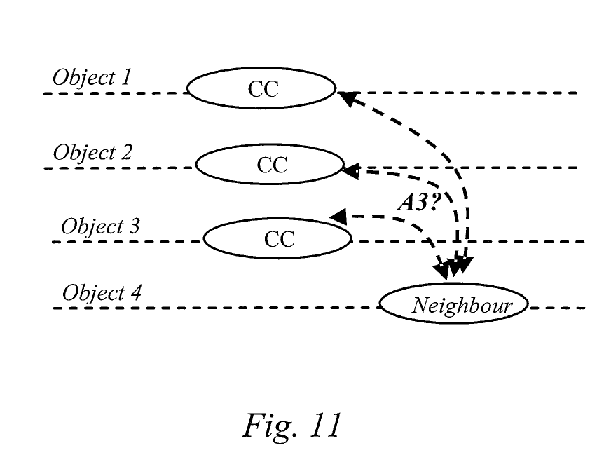

An issue for reducing event evaluations and reports for measurements configured onto objects that include a CC (“intra-frequency”) is how to handle events configured to objects that do not include any CC, as depicted by FIG. 11.

Comparing the inter-frequency neighbor on Object 4 with all CCs on Objects 1 to 3, respectively, may result in redundant measurement reports that do not provide any relevant additional information to the eNB. Such obsolete reports will only load the uplink, from the UE to the eNB, with obsolete traffic. In some scenarios, such repeated reports may increase the probability for a so called Radio Link Failure, in case the UE is unable to deliver the report in the uplink. Such a failure can be triggered, for example, based on too many retransmissions by the RLC protocol layer.

It will be noted that, following the current Rel-8 model, the measurement configuration of Object 4 in the example does not have any “pointer” to a specific “Serving” Cell or CC object.

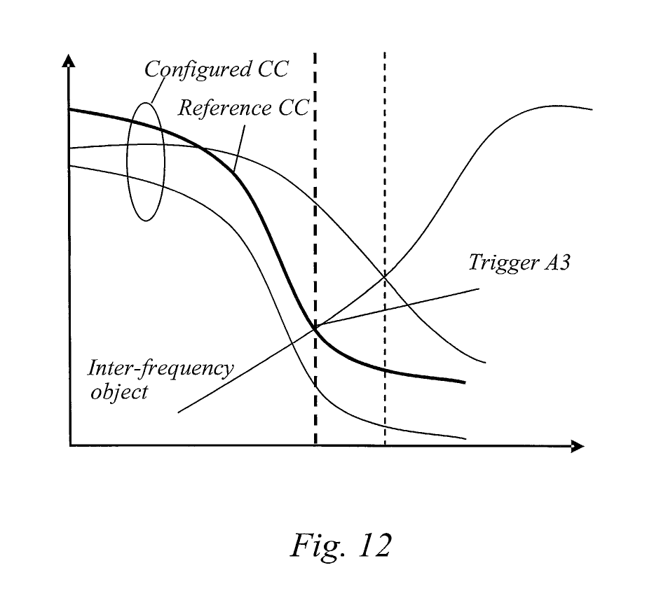

It will also be noted that relative strength between CCs may vary over time. Thus, while one CC might be the best reference at one point of time, another CC might be a better reference later on. This is illustrated in FIG. 12, which is a plot of received signal level vs. time or distance.

Clearly, an A3 event that triggers a measurement report when a specific CC gets weaker than the inter-frequency object in question (plus possible configurable offsets that are not illustrated here) might arrive too early. In FIG. 12 another CC has grown stronger, and the measurement report is now possibly sent pre-maturely, because there is still another CC that is stronger than the concerned inter-frequency object.

In the following, we will now describe the invention using the existing Rel-8 LTE trigger A3 as a specific example:

Event A3: Neighbor becomes amount of offset better than serving; or, formulated with the nomenclature used in this invention:

Event A3: Neighbor becomes amount of offset better than “a reference CC”;

Now, with this description, the inventors have realized that it is ambiguous what CC the UE should evaluate the event against.

This event is often used for identifying a need to perform a handover, i.e. when a neighbor cell is getting stronger compared to the cell (serving) that the UE is currently connected to.

According to the present invention, there is provided the method for measurement event evaluation in UEs configured with multiple downlink component carriers (CCs), where the evaluation criterion is evaluated for the neighbor and a reference CC, where the reference CC is one of the configured CCs.

Instead of evaluating the neighbor against each CC, a basic idea is thus to use only one specific CC as a reference CC.

In a particular embodiment, the reference CC can be the best CC. Alternatively, the reference CC can be selected and controlled with higher-layer signaling, preferably signaled according to the applicable RRC protocol. This control signaling is preferably carried out such that an eNB sends a configuration to the UE. Yet another alternative includes the method of using the CC with the highest bandwidth, best coverage, highest bit-rate or the most recently used CC, where the use may be defined e.g. such that the most recently used CC is the carrier where a grant has been received most recently. The reference CC may also be selected based on a timing-advance parameter, or based on the power needed to support an uplink corresponding to the downlink CC.

As previously mentioned, yet another alternative is to use the so-called PCell, or Primary Cell, as the reference CC. With the PCell as an example of the reference CC, the A3 event for example may be defined as:

Event A3: Neighbor becomes amount of offset better than PCell.

Now, according to another aspect of the present invention, the UE may select different reference CC, when the UE evaluates the Neighbor against the “a reference CC”, such that the reference CC is selected depending on whether UE has a configured CC on the concerned object, which is the carrier on which the Neighbor resides.

In another aspect, if the UE is configured with a CC on the concerned object, then the UE shall evaluate the event against this CC on the concerned object, and if the UE is not configured with a CC on the concerned object, then the UE shall evaluate the event against one of the configured CCs, where this second CC is selected based on another criterion.

In a second embodiment, the other criterion for selecting the CC against which the evaluation is performed can be such that the best or strongest of the CCs is used in the event evaluation.

As an alternative, the second CC can be semi-statically configured using RRC signaling. Alternatively, the reference CC may be selected and assigned with higher-layer signaling, preferably signaled according to the applicable RRC protocol. Yet another alternative includes the method of using the CC with the highest bandwidth, best coverage, highest bit-rate or the most recently used CC, where the use may be defined e.g. such that the most recently used CC is the carrier where a grant has been received most recently. The reference CC may also be selected based on a timing-advance parameter, or based on the power needed to support an uplink corresponding to the CC.

For the Rel-8 A3 event, an enhanced criterion can be for example the following:

Event A3: Neighbor becomes amount of offset better than “a reference CC”, where the reference CC is the CC on the same object as the neighbor, if there is a CC on the same carrier as the neighbor (intra-frequency), or if there is no CC on the same object as the neighbor (inter-frequency), the reference CC is the best of the CCs,

Alternatively:

Event A3: Neighbor becomes amount of offset better than “a reference CC”, where the reference CC is the CC on the same object as the neighbor, if there is a CC on the same carrier as the neighbor (intra-frequency), and the reference CC is configured with RRC signaling, if there is no CC on the same object as the neighbor (inter-frequency).

And yet:

Event A3: Neighbor becomes amount of offset better than “a reference CC”, where the reference CC is the best CC of the configured CCs.

Or:

Event A3: Neighbor becomes amount of offset better than “a reference CC”, where the reference CC is configured with higher layer signaling.

Clearly, the invention is not restricted to the characteristics of the A3 event, but a similar solution can be applied to other events, for example, Events A5 and B2 in Rel-8 LTE, that include evaluations of a “Serving Cell”. Similarly to the solution depicted above, the A5 and B2 events should, according to the present invention, be evaluated against “a reference CC”, where this reference is dependent, for example, on whether the object defined by the concerned Neighbor includes a CC for this UE:

Event A5: “A reference CC” becomes worse than absolute threshold1 AND Neighbour becomes better than another absolute threshold2.

And:

Event B2: “A reference CC” becomes worse than absolute threshold1 AND Neighbour becomes better than another absolute threshold2.

Here, we described only some examples of solutions for the A5- and B2-type of events. Similarly, one can expect new event criteria, where both a neighbor and CC are evaluated, can benefit from the present invention. For example, this may be an A6 event defined as: Intra-frequency neighbor becomes offset better than a reference CC, being the SCell.

Alternatively, and without departing from the present invention, instead of evaluating against the “best of the CCs”, it can be formulated that “any of the CCs” or “all of the CCs” exceed or is below a certain threshold, or fulfills an inequality. This is simply because “any” implies that the “best” exceeds a threshold, while “all” implies that the “best” is below a threshold.

In yet another embodiment, the evaluation of the best (or strongest) CC is performed such that configurable offsets are used in the evaluation, such that a CC may be considered for reference if its measured strength plus a CC-specific threshold makes this CC the strongest among the configured CCs, each of which may have an associated, configurable threshold. Thus, each event that follows the embodiments of the present invention can be equipped with object-specific or CC-specific thresholds or parameters, to achieve the desired triggering of reports when different CCs may have different reference powers on the measured pilots.

The present invention is now illustrated by a simple example:

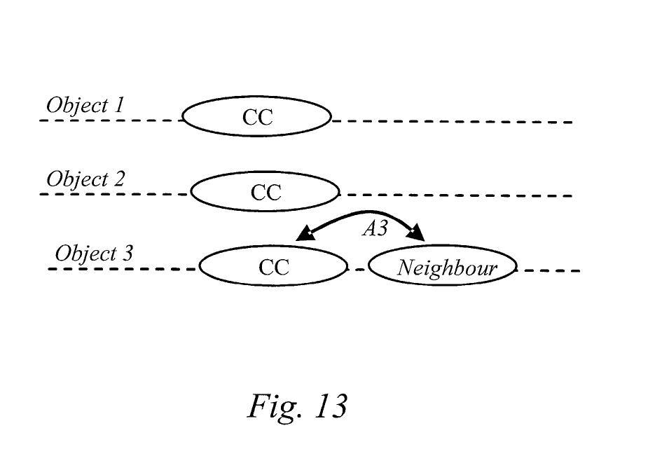

To start with, assume that a UE is configured with three CCs, where Object 3 is configured with a trigger A3. According to an embodiment of present invention, and since the UE has a CC on Object 3 as illustrated by FIG. 13, then the event evaluation is performed on the CC on that carrier. It will be observed that also other measurements on other objects may be configured, but they are omitted in the figures in order to preserve clarity.

Alternatively, the UE may be configured to evaluate against the best CC, in which case the figure illustrates the case when the CC on Object 3 happens to be the strongest of the CCs.

Assume now that the eNB decides to remove the CC on Object 3. Now, without the present invention, it would remain unclear how the A3 trigger should be handled after the CC removal, since the UE would no longer have any CC on Object 3, even though the measurement configuration linked to Object 3 may still apply.

However, and according to the present invention, the UE will now select one of its remaining two CCs to use in its event evaluation for the described measurement on Object 3. In a particular embodiment, this selection is based on the relative strength between the two remaining CCs on Object 1 and Object 2, respectively. The relative strength may be normalized, such that some thresholds are added or removed from the actual measurements before comparisons. Alternatively, some multiplicative factor may be used prior to comparing the measurements of the CCs.

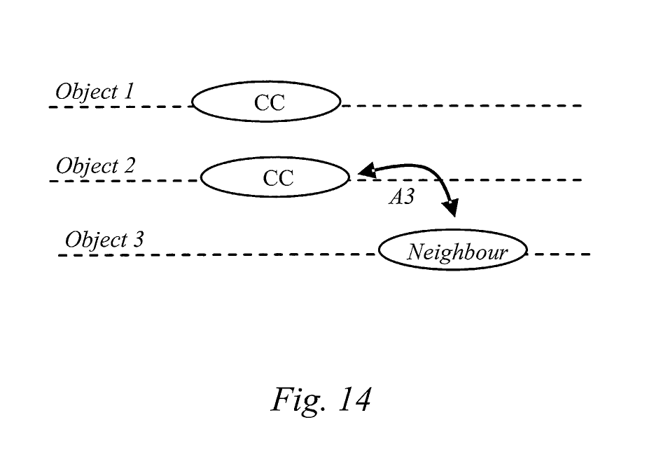

Assume now that the CC on Object 2 is stronger than the CC on Object 1. Then, the UE will compare any neighbors on Object 3 with the CC on Object 2, as illustrated by FIG. 14.

Alternatively, and according to another embodiment of the present invention, the selection of reference CC (between the remaining CCs) may be performed on some other criterion. For example, the reference CC may be controlled explicitly from the eNB using RRC signaling, as previously exemplified. Other alternatives for the CC selection have been described above.

As mentioned, also other events can be implemented using the embodiments of the present invention, in case the UE implements multiple CCs and the event considers an evaluation of a neighbor and a CC.

Note that CC-specific offsets may be configured, such that the UE considers the CC on Object 2 stronger that the CC on Object 1, if the evaluated strength of the CC on Object 2 plus a threshold exceeds the strength of the CC on Object 1 plus a threshold.

It should be noted that the terminology has not been fully settled in the community yet. Thus, it is important to understand that a configured Component Carrier (CC) may also have a different notation, such as “serving cell”. Similarly, the use of the term Neighbor and other notations might also change without departing from the scope of this invention.

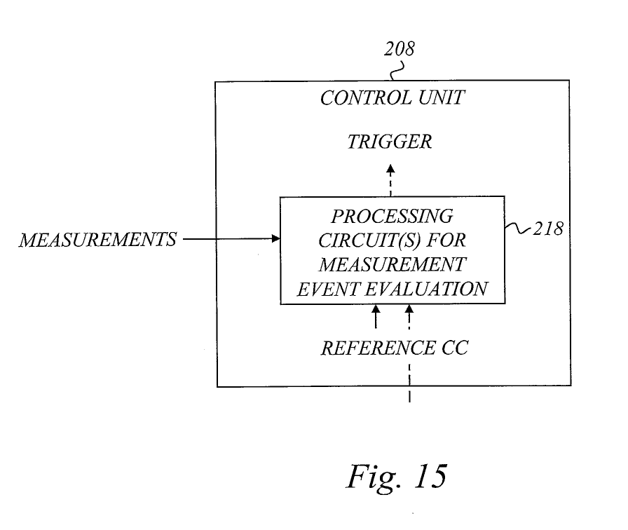

FIG. 15 is a schematic diagram illustrating an example of a control unit for measurement event evaluation according to an embodiment of the invention. The control unit 208 is configured for measurement event evaluation in a user equipment, UE, where the UE is configured with multiple downlink component carriers, CCs, also referred to as serving cells. The control unit 208 comprises one or more processing circuit(s) 218 configured to evaluate, based on measurements of a neighbor and a reference CC, an evaluation criterion for triggering a measurement report from the UE, wherein the reference CC is a specific one of the configured CCs.

The control unit 208 may be configured to receive information about the reference CC via higher-layer signaling, such as Radio Resource Control, RRC, signaling. Alternatively, the control unit 208 decides which one of the configured CCs to use as the reference CC. Anyway, the control unit 208, or alternatively the UE in which the control unit is arranged, will normally be configured to maintain information about the reference CC as the CC to be used in the measurement evaluation. The control unit 208, or the UE, may then request the appropriate measurements of the neighbor and the reference CC, and once the measurement results are obtained, the processing circuit(s) 218 may perform the actual measurement event evaluation. Normally, the control unit 208 is configured to evaluate the evaluation criterion with respect to physical layer measurements related to the neighbor and the reference CC.

In an example embodiment, the control unit 208 and the processing circuit(s) 218 in particular is/are configured to evaluate the evaluation criterion for the neighbor and the reference CC, being the specific one of the configured CCs, where the neighbor is on an inter-frequency carrier on which the UE has no configured CC.

For example, the control unit 208 and the processing circuit(s) 218 in particular may be configured to perform measurement event evaluation of an event selected from the following group of events: A3, A5, and B2 trigger events. In a particular example, the control unit 208 and the processing circuit(s) 218 in particular is/are configured to perform measurement event evaluation of an event defined as: the neighbor becomes amount of offset better than the reference CC.

In the control unit 208, the processing circuit(s) 218 may include one or more programmed processor(s) configured to evaluate the evaluation criterion, as will be explained in more detail later on.

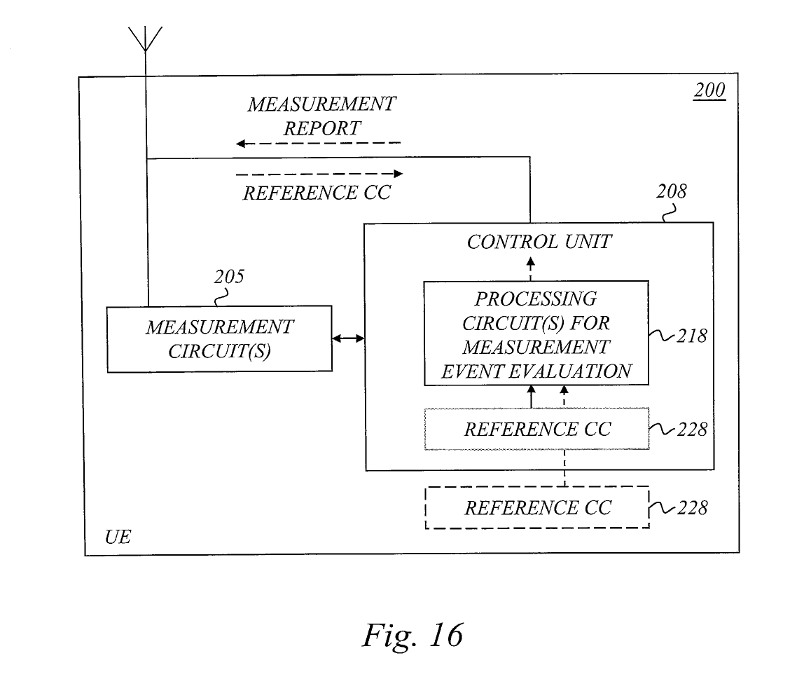

FIG. 16 is a schematic diagram illustrating an example of a user equipment configured for measurement event evaluation according to an embodiment of the invention. The UE 200 comprises one or more measurement circuit(s) 205, and a control unit 208, which in turn comprises one or more processing circuits 218 for measurement event evaluation. The measurement circuit(s) 205 is/are configured to perform measurements of a neighbor and a specific one of the configured CCs, being used as a reference CC. The processing circuit(s) 218 is/are configured to evaluate, for the neighbor and the reference CC, being the specific one of the configured CCs, an evaluation criterion for triggering a measurement report from the UE 200.

The UE 200 may be configured to receive information representative of the reference CC via higher-layer signaling. For example, the information representative of the reference CC may be received via the Radio Resource Control, RRC, protocol, as previously explained.

The UE 200 is preferably configured to maintain information about the reference CC as the CC to be used in the measurement evaluation. This information can for example be maintained in memory 228, which is typically located within the control unit 208 or located externally to the control unit 208 but still within the UE 200.

In an example embodiment, the UE 200 is also configured to send the measurement report, including information about the measured radio environment, to a base station such as a eNB as a result of the measurement event evaluation, to enable the base station to deduce if a handover is needed.

By way of example, the processing circuit(s) 218 includes one or more programmed processors configured to evaluate the evaluation criterion. Other implementations will be discussed later on.

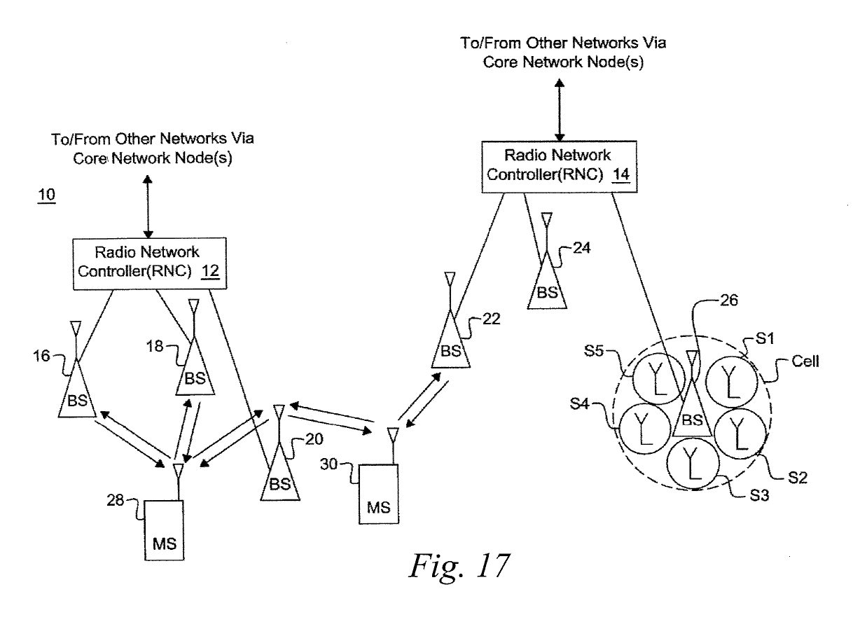

FIG. 17 depicts a typical cellular radio communication system 10. Radio network controllers (RNCs) 12, 14 control various radio network functions, including for example radio access bearer setup, diversity handover, etc. In general, each RNC directs calls to and from a UE, such as a mobile station (MS), mobile phone, or other remote terminal, via appropriate base station(s) (BSs), which communicate with each other through DL (or forward) and UL (or reverse) channels. In the example illustrated in FIG. 17, RNC 12 is shown coupled to BSs 16, 18, 20, and RNC 14 is shown coupled to BSs 22, 24, 26. It should be noted that in LTE, the control functions of the RNC are mainly handled by the BS or eNodeB, i.e. the LTE radio network supports a flatter architecture without any separate control node similar to RNC. The use of WCDMA nomenclature is merely for facilitating for persons with WCDMA knowledge to understand LTE node functionality.

Each BS, or eNodeB in LTE vocabulary, serves a geographical area that is divided into one or more cell(s). In the example illustrated in FIG. 17, BS 26 is shown as having five antenna sectors S1-S5, which can be said to make up the cell of the BS 26, although a sector or other area served by signals from a BS can also be called a cell. In addition, a BS may use more than one antenna to transmit signals to a UE. The BSs are typically coupled to their corresponding RNCs by dedicated telephone lines, optical fiber links, microwave links, etc. The RNCs 12, 14 are connected with external networks such as the public switched telephone network (PSTN), the internet, etc. through one or more core network nodes, such as a mobile switching center (not shown) and/or a packet radio service node (not shown).

It should be understood that the arrangement of functionalities depicted in FIG. 17 can be modified in LTE and other communication systems. For example, the functionality of the RNCs 12, 14 can be moved to the eNodeBs 22, 24, 26, and other functionalities can be moved to other nodes in the network. It will also be understood that a base station can use multiple transmit antennas to transmit information into a cell/sector/area, and those different transmit antennas can send respective, different pilot signals.

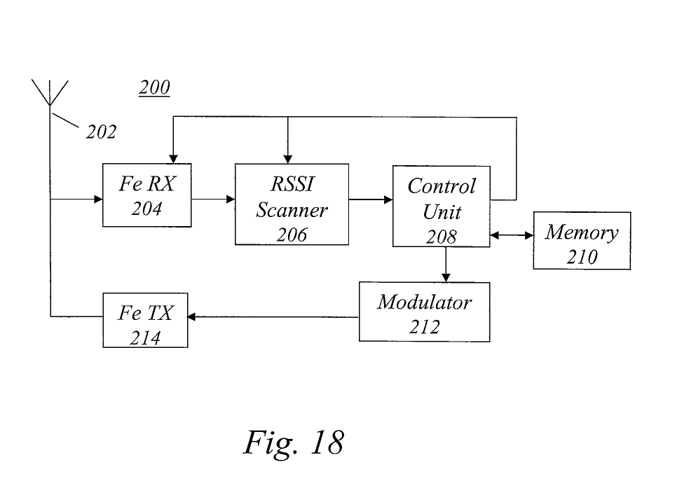

FIG. 18 is a block diagram of an example of a portion of a UE 200 that is suitable for implementing the methods described above. For simplicity, only some parts of the UE 200 are shown in the figure. It will also be understood that the UE can be implemented by other arrangements and/or combinations of the functional blocks shown in FIG. 18.

Signals from eNBs are received through an antenna 202 and down-converted to base-band signals by a front-end receiver (Fe RX) 204. On a regular basis for all detected cells, the received signal code power (RSCP) is estimated and the received signal strength indication (RSSI) is computed by an RSSI scanner 206 that operates under the control of a control unit 208. An RSCP can be estimated by, for example, de-spreading the base-band signal from a detected cell with the scrambling code (and common pilot channel (CPICH) channelization code) corresponding to the cell. In LTE, cell-specific or UE-specific reference symbols may be used. Methods of computing RSSIs are well known in the art. In suitable communication systems, for example, the RSSI can be estimated by computing the variance of the received signal over a given time period.

The control unit 208 uses the RSSI scan information in identifying radio carriers and analyzing the UE's radio environment according to the methods described above. The control unit 208 stores information determined in the analysis in a suitable memory 210, and retrieves stored information as needed. Based on the results of such searches and other information, the control unit 208 controls the operation of the Fe RX 204 and scanner 206 to carry out cell searches and other procedures specified for the wireless communication system as described above. Thus, the FE RX 204, scanner 206, and control unit 208 form an analyzer configured to analyze received radio signals transmitted by at least one cell in the wireless communication system and to determine information about a radio environment of the receiver by analyzing the received radio signals. It will be appreciated that the UE 200 also typically includes a modulator 212 and a front-end transmitter (Fe TX) 214 and other devices for sending information to the network and using received information.

The control unit 208 and other blocks of the UE 200 can be implemented by one or more suitably programmed electronic processors, collections of logic gates, etc. that processes information stored in one or more memories 210. The stored information can include program instructions and data that enable the control unit to implement the methods described above. It will be appreciated that the control unit typically includes timers, etc. that facilitate its operations.

It will be appreciated that the methods and devices described above can be combined and re-arranged in a variety of equivalent ways, and that the methods can be performed by one or more suitably programmed or configured digital signal processors and other known electronic circuits (e.g., discrete logic gates interconnected to perform a specialized function, or application-specific integrated circuits). Many aspects of this invention are described in terms of sequences of actions that can be performed by, for example, elements of a programmable computer system. UEs embodying this invention include, for example, mobile telephones, pagers, headsets, laptop computers and other mobile terminals, and the like. Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions.

In general, the steps, functions, procedures and/or circuits described above may be implemented in hardware using any conventional technology, such as discrete circuit or integrated circuit technology, including both general-purpose electronic circuitry and application-specific circuitry.

Alternatively, at least some of the steps, functions, procedures and/or blocks described above may be implemented in software for execution by a suitable computer or processing circuit such as a microprocessor, Digital Signal Processor (DSP) and/or any suitable programmable logic device such as a Field Programmable Gate Array (FPGA) device and a Programmable Logic Controller (PLC) device.

It should also be understood that it may be possible to re-use the general processing capabilities of any conventional unit. It may also be possible to re-use existing software, e.g. by reprogramming of the existing software or by adding new software components.

The software may be realized as a computer program product, which is normally carried on a computer-readable medium, for example a CD, DVD, USB memory, hard drive or any other conventional memory device. The software may thus be loaded into the operating memory of a computer for execution by the processor of the computer. The computer/processor does not have to be dedicated to only execute the above-described steps, functions, procedure and/or blocks, but may also execute other software tasks.

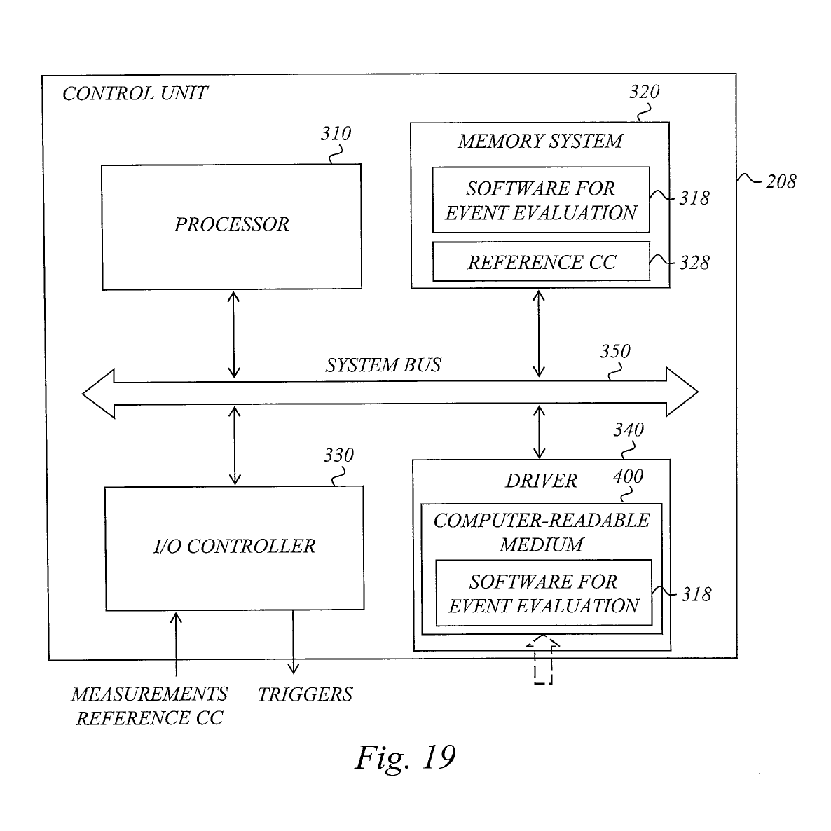

In the following, an example of a computer implementation of a control unit will be described with reference to FIG. 19.

FIG. 19 is a schematic diagram illustrating an example of a computer-implemented control unit for measurement event evaluation, as well as a computer-readable medium according to an embodiment. The computer-implemented control unit 208 illustrated in the example of FIG. 19 comprises a processor 310, a memory system 320, and input/output (I/O) controller 330, a driver 340 for a computer-readable medium 400, and a system bus 350.

In this example, the relevant steps, functions and/or procedures for measurement event evaluation are implemented in software 318 for event evaluation and carried on the computer-readable medium 400.

The computer-readable medium 400 is inserted into the driver 340, and the software 318 is loaded into the memory system 320 via the system bus 350. The processor 310 and the memory system 320 are also interconnected via the system bus 350 to enable normal software execution.

The I/O controller 330 is interconnected to the processor and/or the memory system via the system bus 350 or a dedicated I/O bus (not shown) to enable input and/or output of relevant data such as input parameter(s) and/or resulting output parameter(s). More particularly, the I/O controller 330 may receive information about the reference CC as input, for possible storage of this information in a suitable memory location 328 in the memory system 320. The I/O controller 330 may also receive measurements of a neighbor and the reference CC as input, and provide report triggers and/or actual measurement reports from the event evaluation as output.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

What is claimed is:

1. A method of evaluating a measurement event in a user equipment (UE) configured with multiple downlink component carriers (CCs), comprising:
performing measurements of a neighbor and a specific one of the configured CCs, being used as a reference CC; and
evaluating, based on the measurements of the neighbor and the reference CC, being the specific one of the configured CCs, an evaluation criterion for triggering a measurement report from the UE.

2. The method of claim 1, further comprising receiving information representative of the reference CC, the reference CC being either selected and controlled with higher-layer signaling or signaled using a Radio Resource Control protocol.

3. The method of claim 2, further comprising maintaining information about the reference CC as the CC to be used in the measurement event evaluation.

4. The method of claim 1, wherein the UE evaluates the evaluation criterion for the neighbor and the reference CC, being the specific one of the configured CCs, where the neighbor is on an inter-frequency carrier on which the UE has no configured CC.

5. The method of claim 1, wherein the measurement event evaluation includes evaluation of an event selected from the following group of events: A3, A5, and B2 trigger events.

6. The method of claim 1, wherein the measurement event evaluation includes evaluation of an event defined as: the neighbor becomes amount of offset better than the reference CC.

7. The method of claim 1, wherein the evaluation criterion is evaluated with respect to physical layer measurements related to the neighbor and the reference CC.

8. The method of claim 1, further comprising sending the measurement report, including information about the measured radio environment, from the UE to a base station as a result of the measurement event evaluation, to enable the base station to deduce if a handover is needed.

9. A control unit for measurement event evaluation in a user equipment (UE) configured with multiple downlink component carriers (CCs), comprising at least one processing circuit configured to evaluate, based on measurements of a neighbor and a reference CC, an evaluation criterion for triggering a measurement report from the UE, wherein the reference CC is a specific one of the configured CCs.

10. The control unit of claim 9, wherein the control unit is configured to receive information about the reference CC, either the reference CC being selected and controlled with higher-layer signaling or the information being received via Radio Resource Control signaling.

11. The control unit of claim 10, wherein the control unit is configured to maintain information about the reference CC as the CC to be used in the measurement evaluation.

12. The control unit of claim 9, wherein said at least one processing circuit is configured to evaluate the evaluation criterion for the neighbor and the reference CC, being the specific one of the configured CCs, where the neighbor is on an inter-frequency carrier on which the UE has no configured CC.

13. The control unit of claim 9, wherein the at least one processing circuit is configured to perform measurement event evaluation of an event selected from the following group of events: A3, A5, and B2 trigger events.

14. The control unit of claim 9, wherein the at least one processing circuit is configured to perform measurement event evaluation of an event defined as: the neighbor becomes amount of offset better than the reference CC.

15. The control unit of claim 9, wherein the at least one processing circuit is configured to evaluate the evaluation criterion with respect to physical layer measurements related to the neighbor and the reference CC.

16. The control unit of claim 9, wherein the at least one processing circuit includes at least one programmed processor configured to evaluate the evaluation criterion.

17. A user equipment (UE) configured for measurement event evaluation and with multiple downlink component carriers (CCs), comprising:
at least one measurement circuit configured to perform measurements of a neighbor and a specific one of the configured CCs, being used as a reference CC; and
at least one processing circuit configured to evaluate, for the neighbor and the reference CC, being the specific one of the configured CCs, an evaluation criterion for triggering a measurement report from the UE.

18. The user equipment of claim 17, wherein the UE is configured to receive information representative of the reference CC via either higher-layer signaling or a Radio Resource Control protocol.

19. The user equipment of claim 18, wherein the UE is configured to maintain information about the reference CC as the CC to be used in the measurement evaluation.

20. The user equipment of claim 17, wherein the UE is configured to send the measurement report, including information about the measured radio environment, to a base station as a result of the measurement event evaluation, to enable the base station to deduce if a handover is needed.

21. The user equipment of claim 17, wherein the at least one processing circuit includes at least one programmed processor configured to evaluate the evaluation criterion.

22. A non-transitory computer-readable medium having stored therein a set of instructions for performing, when executed by a computer-based system, measurement event evaluation in a user equipment (UE) configured with multiple downlink component carriers (CCs), wherein an evaluation criterion for triggering a measurement report from the UE is evaluated for a neighbor and a reference CC, where the reference CC is one of the configured CCs.
